(19) United States
(12) Patent Application Publication
(10) Pub. No.: US 2019/0377906 A1
(43) Pub. Date: Dec. 12, 2019

(54) AERONAUTICAL CYBERSECURITY

(71) Applicant: THALES, COURBEVOIE (FR)

(72) Inventors: Dominique RIVIERE, TOULOUSE (FR); Philippe BERTHE, TOULOUSE (FR); Nathalie FEYT, TOULOUSE (FR)

(21) Appl. No.: 16/434,585

(22) Filed: Jun. 7, 2019

(30) Foreign Application Priority Data
Jun. 7, 2018 (FR) 1800577

(51) Int. Cl. G06F 21/71; G06F 21/55; G06F 21/57; G06N 20/00

(52) U.S. Cl. CPC G06F 21/71; G06F 21/554; G06F 21/552; G06N 20/00; G06F 21/577

(57) ABSTRACT

Systems and methods for managing the security of an aircraft with a view to ensuring the aeronautical safety thereof are provided. A method can include identifying one or more security anomalies as a function of one or more processes applied to records collected and/or received. Different objects are handled, notably security anomalies, qualified alerts, cyberattacks, etc. Reference data can be accumulated, consolidated and learned over time. The flight of an aircraft is compared to the knowledge base thus constituted and enriched. Developments describe the scope of avionics security, the use of flight phases, the triggering of comparisons, the granularity of the request system, data processing including heuristics, statistical analyses on an aircraft or a fleet of aircraft. Software and architectural aspects are described (centralized, decentralized or distributed processors).

### CROSS-REFERENCE TO RELATED APPLICATIONS

This application claims priority to foreign French patent application No. FR 1800577, filed on Jun. 7, 2018, the disclosure of which is incorporated by reference in its entirety.

### FIELD OF THE INVENTION

The invention relates to the domain of cybersecurity methods and systems in the aeronautical sector.

### BACKGROUND

The aeronautical sector is subject to cyber-attacks. The introduction of IP technologies in the cockpit and developments in cockpit connectivity increase the attack surface.

In the field of cybersecurity, the regulatory authorities in the aeronautical sector require the source of a malfunction affecting the safety of an aircraft flight to be determined, in particular the malicious nature thereof. The aircraft must therefore have mechanisms for capturing security events and detecting anomalies as close as possible to the most critical functions.

The software currently available on the market relates to a technical domain other than avionics, there being no specific solutions for this domain.

In the generic domain of information technology (IT), the existing software relates in general to surveillance of information security and event management, commonly referred to as ‘Security Information and Event Management’ (SIEM). The components of the information systems generate numerous execution traces (referred to as notification messages or ‘logs’) in their operating environment. Existing SIEM software performs different functions, notably (a) collection (context, logs and events in an information system), (b) grouping (standardization, aggregation of logs and events), (c) analysis (for example correlation and hierarchization), (d) presentation (for example generation of reports and displaying), and (e) conservation (for example retention and archiving with probative value).

In general and in terms of form, SIEM methods and systems cannot be deployed, i.e. carried on board aeroplanes currently in use, in the cockpit domain, notably as a result of constraints to critical resource management and the complex logistics relating to updates and certification that would result, where applicable.

In terms of content, this SIEM software and methods are not suited to the very specific constraints and contexts found in the aeronautical sector.

Numerous specific technical problems are posed in the avionics sector that are not even considered in information system management in similar office or industrial contexts.

Patent literature in the general domain of information management or specifically in the avionics sector does not provide a solution to the mentioned problem. For example, patent document FR2944117 discloses methods and devices for managing events relating to the security of aircraft information systems. The document teaches the use of predetermined rules for characterizing events to enable the preparation of a security report. This approach is of interest, but has limitations.

There is a need for advanced methods and systems for securing information systems carried on-board one or more aircraft that are currently in service (‘retrofit’) or planned (‘linefit’).

### SUMMARY OF THE INVENTION

The invention relates to systems and methods for managing the security of an aircraft with a view to ensuring the aeronautical safety thereof. A method can include identifying one or more security anomalies as a function of one or more processes applied to records collected and/or received. Different objects are handled, notably security anomalies, qualified alerts, cyberattacks, etc. Reference data can be accumulated, consolidated and learned over time. The flight of an aircraft is compared to the knowledge base thus constituted and enriched. Developments describe the scope of avionics security, the use of flight phases, the triggering of comparisons, the granularity of the request system, data processing including heuristics, statistical analyses on an aircraft or a fleet of aircraft. Software and architectural aspects are described (centralized, decentralized or distributed processors).

The method according to the invention notably enables a collection, for example a continuous collection for aircraft with operational transmission means, of data coming from aircraft forming the fleet being monitored. The data collected can be saved or analysed to detect and diagnose security events.

Advantageously, the invention makes it possible to detect or diagnose a security event during operation of a connected aircraft.

Advantageously, the invention can be used by airline companies operating different types of aircraft on different flight segments that need to ensure the capture and analysis of security events in order to adapt protection solutions to the threat.

Advantageously, the invention enables the detection of Advanced Persistent Threats.

Advantageously, the method according to the invention makes it possible to carry out post-incident analyses (for example to confirm or deny the veracity of a cyberattack claimed, or to evaluate the impact of a confirmed attack in terms of operational security).

Advantageously, the method according to the invention expands the scope of the data taken into account, notably using records from on-board systems in the avionics domains ACD and AISD (regulatory and maintenance records) as well as traces and logs from the PIESD domain, although these are not primarily intended for aircraft security.

The methods and systems according to the invention enable IT devices and software programs on the ground to be used to monitor the entire fleet of aircraft, including different types of aeroplanes. These aircraft can be operated in different ways, for example over several commercial services. A flight segment is shown by a point, a departure airport and an arrival airport.

Advantageously, the invention can provide responses to specific technical problems relating to avionics, notably the analysis and monitoring of a fleet of aircraft, the management of vulnerabilities, and the management of specific countermeasures, etc. For example, an attack on a specific type of aircraft can be perpetrated on other aircraft of the same type and/or taking advantage of lessons learned from previous failures. An attack can be perpetrated on different aeroplanes, for greater stealth, which requires specific prior analysis. A given aircraft can be equipped in different ways, such as with entertainment systems connected in very different ways, and even avionics devices. Fleets of assorted aircraft (or different arrangements of elements of the fleet) can be handled differently.

Advantageously, the method according to the invention can take account of developments in aircraft configurations resulting in the appearance or disappearance of types of notification without thereby requiring the component parts thereof to be modified.

Advantageously, embodiments of the method according to the invention can enable the identification or improved identification of attacks and the steps comprising such attacks.

Advantageously, the invention does not require any specific training or skills in cybersecurity.

Advantageously, the invention can be implemented using existing aircraft equipment and can incorporate future developments, notably regarding the integration of avionics applications able to generate notification messages or logs.

Advantageously, the method according to the invention makes it possible to filter and/or select traces or logs with a view to extracting genuine symptomatic elements of an attack or of a security event, to compare said elements with one another, and incidentally to lessen the associated analysis workload.

Advantageously, and in contrast with the prior art, once the analysis processes have been carried out (either in current system administration mode or in forensic mode, i.e. post event analysis), the data can still be used to improve the different services rendered, in particular analysis.

### DESCRIPTION OF THE FIGURES

Other features and advantages of the invention are set out in the description below and the figures in the attached drawings, in which:

FIG. 1 shows the general environment of the invention,

FIG. 2 shows examples of the steps of one embodiment of the invention,

FIG. 3 shows other examples of the steps of one embodiment of the invention.

### DETAILED DESCRIPTION

Some technical environments and terms are defined below.

An aircraft is a means of transport able to move through the Earth's atmosphere. For example, an aircraft can be an aeroplane or a helicopter, or even a drone.

The abbreviation SOC means ‘Security Operations Centre’. This service is a ground service operated by the airline company. This SOC is used to collect, detect, analyse, process and manage (security) incidents. This SOC can be used to store, analyse, sort or select data, and to correlate other information (data) corroborating flights.

The abbreviation EFB means ‘Electronic Flight Bag’ and refers to on-board electronic libraries. An EFB is a portable electronic device used by flight crew. This electronic support can notably be used in place of the paper documentation used in the past.

The abbreviation HMI means ‘Human-Machine Interface’. The entering of information and the display of the information entered or calculated using display means constitute such a human-machine interface. In general, HMI means enable information on the flight plan, piloting data, etc. to be entered and consulted.

A ‘log’ is the record of an event with which a probability distribution is associated. The use of logs is a first approach for establishing frequency and probability distributions characteristic of recorded events. The term ‘record’ can also be used here.

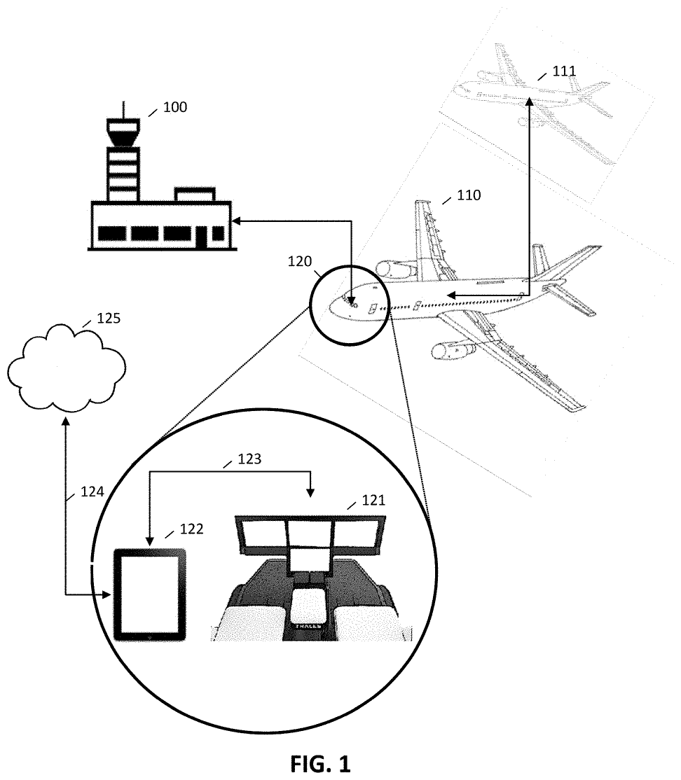

FIG. 1 shows the overall technical environment of the invention.

An aircraft has a cockpit and avionics bays 120. These bays contain piloting avionics equipment 121, optional avionics equipment (also certified) and optional non-avionics equipment, use of which is approved by the aeronautical regulator by means of an operational approval. ‘Open world’ equipment can also be installed on board.

Ground means (operational control centres, design offices, SOC, etc.) 100 are in communication with an aircraft 110. The aircraft includes a cockpit 120. Inside the cockpit, there is piloting equipment 121 (referred to as avionics equipment) including for example one or more on-board processors (data storage, memory and processing means), notably including one or more avionics piloting systems, as well as (but not only) data entry and display or viewing means, communication means and (potentially) haptic feedback means. The IT resources can be local and/or accessed remotely (for example cloud computing 125), notably using secure routers (data encryption).

Several aircraft, for example 110 and 111 can communicate (directly and/or indirectly).

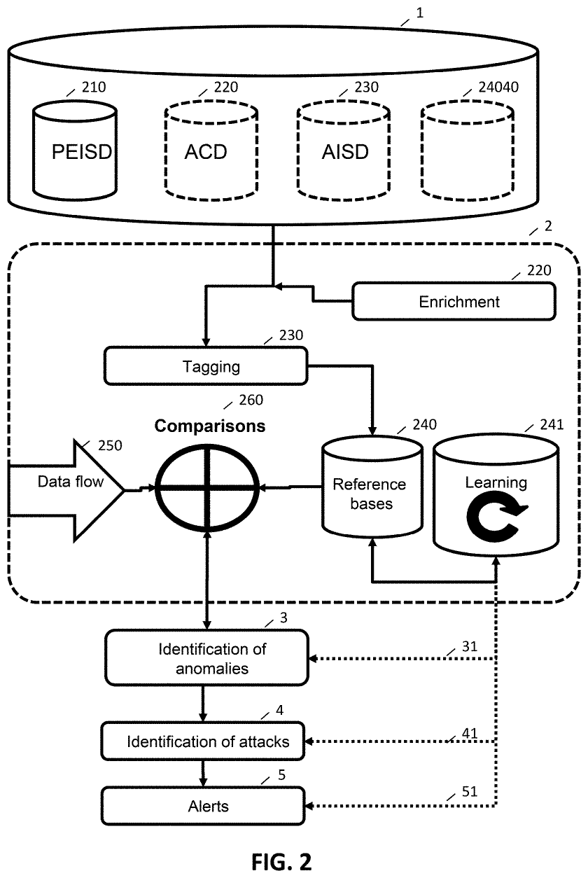

FIG. 2 shows examples of the steps of the embodiments of the invention,

In one embodiment, the method includes a step of actively and easily connecting data (1), processing this data (2), identifying anomalies (3) from the processing of this anomaly data, then potentially identifying cyberattacks (4), and finally issuing the alert (5) where applicable.

In one embodiment, a method is described for managing the security of an aircraft, comprising steps of actively collecting and/or passively receiving (1) records associated with the aircraft, identifying (2) one or more security anomalies as a function of one or more processes applied to said records. The term ‘security’ refers to ‘security for aeronautical safety’. This security therefore includes IT security, in particular for systems in the ACD domain, but in general via the information system of the aircraft. The security of the aircraft also includes the physical (or hardware) security and logic security of the aircraft. The plane can be subject to various different attacks, from external physical attacks (for example electromagnetic pulse or blinding laser) to internal logic attacks (for example piracy by insertion of malware via USB ports made available to passengers).

In one embodiment, the method also includes a step (3) in which one or more cyberattacks are identified as a function of one or more security anomalies. According to the embodiments, several intermediate objects can enable the occurrence of anomalies (relative deviations from known situations or abnormal or extreme data). For example, several ‘security anomalies’ can result in one or more ‘qualified alerts’ (false positives, false negatives, true positives, etc.) that can identify (by application of alert thresholds) one or more ‘security attacks’ (for example ‘cyberattacks’) that can in turn be associated (in a predefined or dynamic manner) with one or more ‘reactions’ or ‘countermeasures’. The actions or roles or identifications or attenuations or modifications or modulations are shared between the person and/or the machine (for example instructions coded in software form, airline company requests conditioning or influencing requests from aircraft manufacturers that are in turn conditioning, etc.).

In one embodiment, the method also includes a step of sending (4) one or more alerts. The alerts can be messages that can be displayed analogically or otherwise (digital, analogue). The alerts can be qualified, i.e. categorized or classified by the person and/or the machine.

In one embodiment, the processing step includes one or more of the steps of constituting (or maintaining or producing or determining) the reference data, and comparing each record collected with said reference data. The reference data are modified parsimoniously. The reference data can form a knowledge base, i.e. knowledge constituted by the accumulation of continuously refined data for ‘normal’ or ‘acceptable’ values associated with a flight with no incidents, anomalies or attacks. The reference data can include thresholds or threshold ranges, priorities, weightings, differentiated criticalities, ‘envelopes’ of values or ‘tolerances’, etc.

In one embodiment, the reference data include descriptions or metadata or tags or labels associated with flight records to enable non-ambiguous imputation of a security anomaly to an on-board device. The non-ambiguous imputation can be defined in space and/or time.

In one embodiment, the non-ambiguous imputation is effected during a predefined operating phase or a predefined flight phase. For example, it can be determined that attempted attacks can take place on the on-board entertainment equipment, specifically during take-off.

In one embodiment, one or more reference data are modified by machine learning. By construction, the reference data constitute carefully structured data (filtered, validated, etc.). The learning methods modify the reference data parsimoniously. The meaning of the verb ‘modify’ potentially involves both additions and deletions, and therefore data substitutions. It is incidentally noted that the regulatory data that has to be kept in original format (logbook or other logs) continues to be kept in that format (not shown on the drawings). The data can by definition be copied and it is implicit that the copies of the original data are subsequently handled by the embodiments of the invention.

According to one embodiment, the reference data include data associated with one or more information points including the registration of an aircraft, an aircraft type, a flight number, the identification of a flight, a time date expressed as year, month, day, hour, minute or second, a time interval, a flight time, an aeronautical service, a flight segment, an IATA code of the departure and/or arrival airport and/or the presence of at least one specific hardware device on board. The request system can in fact have fine granularity, for example: it is possible to search all of the aeroplanes with a type X anomaly over a long-haul service and a particular period of time. It is also possible to compare all A320 flights according to specific criteria, etc.

In one embodiment, a process is carried out on a record to compare said flight record with the reference data. This embodiment emphasizes the ‘unitary’ processing of a record in the data flow received.

In one embodiment, the comparison step is triggered on demand from the ground and/or as a function of flight context. The triggering of certain comparisons can be controlled autonomously or automatically on board, as well as on demand (for example by the pilot or the ground machines or teams, or the ATC, etc.). The flight context denotes several objects, notably the flight phase (take-off, cruising, etc.), piloting events, or even crossing points in the flight plan. Triggering can be explicit or implicit (inferred from information coming from the airline company, for example).

According to one embodiment, a process involves carrying out a comparative statistical analysis of the records collected with the reference data. This embodiment emphasizes the statistical processing of data (rare or exceptional event, recurrent events, etc.).

In one embodiment, the comparative statistical analysis is carried out for a given aircraft. This embodiment specifies the scope of the statistical processing, in this case an aircraft.

In one embodiment, the comparative statistical analysis is carried out for several aircraft. This embodiment broadens the scope of the statistical processing, and this case relates to the fleet of aircraft (such as all of the aeroplanes of a given company, or all aeroplanes worldwide, using standardized data exchanges).

In one embodiment, one or more records collected and/or received are associated with one or more aircraft. This embodiment leverages the fact that the data on all aeroplanes, or on a maximum number thereof, can be used to manage security to ensure the aeronautical safety of a given aircraft. The term ‘associated’ highlights the existence of a link. The verb ‘compare’ presupposes that certain data are linked in advance.

In one embodiment, the method also includes a step involving receiving feedback regarding any one of the steps in the preceding claims. The term ‘feedback’ means a quantitative modification and/or a qualitative assessment regarding an object or an intermediate step of the method. For example, the method can include one or more feedback loops (or feedforward mechanisms) regarding the production, creation, maintenance or learning of reference data (airline companies, aircraft manufacturers, equipment suppliers), the qualification of security anomalies (airline companies), the definition of alert thresholds (airline companies), the adaptation of countermeasures (airline companies, aircraft manufacturers, equipment suppliers), etc. As a function of the feedback received, the steps of the method can be modified (attenuated, weighted, maximized, accelerated, etc.). For example, the following objects can be handled: identification of an anomaly (and the qualification criteria thereof), identification of an attack, determination of a reaction or a countermeasure, updating of one or more alert thresholds, acceptance or rejection of one or more data in the reference data, qualification of an alert issued by the security centre on the ground and/or an in-flight intervention request, acceptance or rejection or modification of a countermeasure procedure in response to an attack, etc.

Advantageously, the precautions, measures, deeds, actions, reactions and countermeasures in the field of cybersecurity are handled using algorithms, which is advantageous compared to the existing regulations for which cyber knowledge is not required by the pilot. The reaction times associated with hardware and/or software implementations excluding the human factor are also advantageous since said reaction times are rapid (as quick or quicker than the attacks). Effectively, IT defence can be proactive or pre-emptive.

A computer program product is described, said computer program including code instructions enabling one or more steps of the method to be carried out when said program is run on a computer.

A system for managing the security of an aircraft is described in which the system comprises one or more processors configured to actively collect and/or passively receive records associated with the aircraft, and to identify one or more security anomalies as a function of one or more processes applied to said records. In one embodiment, the system includes a plurality of processors arranged using a centralized or decentralized or distributed architecture.

Data can be collected actively (request, on demand, data mining, etc.) and/or passively (receipt of a data flow from the outside).

According to one embodiment of the invention, information of all types is received or collected then consolidated, notably flight data, regulatory data and non-regulatory data: PEISD 210, ACD 220, AISD 230 or other domains 240.

The abbreviation PEISD 210 (‘Passenger Entertainment Information System Domain’) refers to the information system and related equipment dedicated to passenger entertainment. The network of the equipment involved is either isolated from the cockpit equipment and the AISD equipment, or connected to the AISD equipment network by a secure communication router. This domain can be an attack vector (USB ports made available to passengers).

The abbreviation ACD corresponds to ‘Aircraft Control Domain’ and refers to all of the electronic systems dedicated to managing the flight, including surveillance and maintenance systems for these same systems. All of the related equipment is found in the cockpit or as close as possible to the mechanical elements required to operate the aircraft that said equipment is controlling or monitoring, such as the braking systems.

The abbreviation AISD (‘Airline Information System Domain’) refers to the on-board information system of the airline company. The network of related equipment is either isolated from the cockpit equipment, or linked in diode mode, i.e. with a single information flow direction from the ACD to the AISD, or connected to the ACD via a secure communication router.

Other sources of information are not shown 240: data from the EFBs provided by the pilot or the flight crew, and data taken from the ‘open world’ (initially received by the airline company then selected and/or filtered by this latter).

For example, data related to an aircraft type advantageously specify the presence of an on-board entertainment system (which could contain security flaws) and/or the presence of an on-board secure router. The presence of such elements can be mentioned in the file named ‘config avion’.

The records advantageously include PEISD logs, as well as some or all of the available records concerning aircraft, said records being associated with the operation of the on-board systems of an aircraft (or several aircraft), for example as a function of the different operating phases (or ‘contexts’) given.

The recording of flight parameters is mandatory to explain any problems related to the aeroplane during incidents or accidents. These imports, which may be partial (continuous import) or full (import after operating phase) can be used and compared with different sets of corresponding reference data.

The records can include flight data, including regulatory flight parameters.

In one embodiment, a record collected or received is associated with the avionics domain from whence said record came, an aircraft number, the identification of a flight and the entry date in the SOC ground system.

In one embodiment, a record is issued by an avionics system or an EFB or any other application in the cockpit from an avionics source in the PIESD, AISD, ACD domains from one or more aircraft.

In one embodiment, the data collected are expanded to the following data types: ACARS, ARINC, METAR (observed weather), TAF (forecast weather), NOTAM (notice to airmen), OOOI (markers of time blocks generated by the aeroplanes autonomously, for example: doors closed, take-off, landing, doors open), technical QAR/FDR data (navigation and root data, mission management data and identity data), report data (CMS), etc.

In one embodiment, the method includes a step for enriching 220 the data collected. Enrichment means cross-referencing data, formatting data, establishing correlations between data, etc. In one embodiment, the step of enriching the PEISD, ACD and AISD data is aimed at open-world data (Internet) previously validated by the airline company (for example: weather data that could be falsified and that therefore requires prior validation before entry into the system using the decision according to the invention).

In one embodiment, the method includes a step of tagging 230 (or attaching a label, or identifying, or time stamping). This tagging can be implemented technically in different ways, by concatenation, hash values, time stamping, etc.

Tagging notably makes it possible to associate or aggregate or consolidate data from the different domains involved (which may be expanded).

Advantageously, the data are then consolidated in ‘reference bases’ 240, which represent records that are normal or nominal or ‘anomaly free’ and associated with a flight plan segment or a flight plan or an aeronautical service (such as from an airport A to an airport B) or to any type of criteria that is or can be associated with the flight of one or more aircraft (‘common denominators’).

An incoming data flow 250 measured or received by a given aircraft is then compared with one or more reference bases 240 (or ‘reference data’).

The processes or comparisons made on said records or logs include one or more operations, including running heuristics, one or more static or dynamic comparisons (not exclusive).

In one embodiment, a process performed on a record involves comparing the flight parameters as a function of the contextual data of the flight, weather data, the list of on-board equipment and assets. These comparisons make it possible to establish a detailed report including data on the flight to be submitted to the team in charge of maintaining the secure condition of the fleet being monitored, which can then request the appropriate solution: (a) incorporate unreferenced notifications into the reference sets, (b) incorporate the new notification counts to recalculate the frequency thereof in the reference sets, (c) provide a detailed report to a supplier of the product generating the notification to be clarified.

According to one embodiment, a process involves carrying out a comparative statistical analysis of the data collected by correlation analysis.

The method can include steps involving comparing the records of identical and/or similar flights undertaken using different aircraft (measure of similarity, distance, etc.). In one embodiment, the comparative statistical analysis comprises a statistical analysis of all of the data and associates each record with the observed frequency thereof. In one embodiment, a process involves determining the traces and/or events not designed for security surveillance, i.e. weak signals revealing attacks or attempted attacks.

In one embodiment, the processes implemented can be modified as a function of or to suit developments in avionics (additional security logs, additional equipment, alert thresholds, definition of criticalities, etc.).

In one embodiment, a learning mechanism 241 is applied to the reference bases or data 240.

Indeed, ‘machine learning’ steps can be implemented. Different types of learning can be used, and learning may notably include the steps of supervised learning, semi-supervised learning, learning by reinforcement, learning by transfer, deep learning or federated learning. Different algorithms can be used, notably support-vector machines, ‘boosting’, neural networks, the k-nearest neighbours method, ‘random forest’ decision trees, Gaussian mixtures, logistic regression, linear discriminant analysis, genetic algorithms and genetic programming. Algorithms such as expectation-maximization, principal component analysis, self-organizing maps, etc. can also be used.

By pooling the data collected on a large scale (between airline companies, regulators, etc.), the resulting learning databases can be constituted (real data, but also calculated data or simulated attacks, etc.).

For example, in one embodiment, the learning mechanism 241 includes one or more of the learning techniques selected from unsupervised machine learning, supervised machine learning, and deep learning.

In one embodiment, the learning mechanism takes account of (for example is weighted by) the feedback received following the steps carried out previously (identification of anomalies 3, identification of the attacks 4, and alerts raised 5). According to the embodiments, the creation and maintenance of reference data is significantly manual (automated at the fringes) or significantly automated (manual checks at the fringes). In certain embodiments, the creation and maintenance of reference data is exclusively automatic (‘big data’).

In one embodiment, the processing of avionics data can use one or more learning techniques. The constitution of the reference bases can correspond to the creation of the data set for the application of binary classification algorithms. In one embodiment, the dimension taken into account to establish the model is the frequency of appearance of the logs, which is calculated and associated with each log on entry of the data if the data is not present in the record or if the log is opaque, i.e. of the binary data and therefore not in text form.

In one embodiment, a first classification step can be used to determine, in an approaching context (for example same segment, same aeroplane type), whether the logs pertain to a security event by comparing the frequency thereof or any other digital attribute used to assess the presence thereof in the reference base, and an alert is raised where applicable. In one embodiment, implementation of the model can use the naive approach: the first data are considered to be not associated with the detection of an attack, i.e. the data are not identified as being linked to an attack. A first variability threshold of these digital attributes is mathematically defined for each log. Subsequently, this threshold is updated by learning by re-entering new data following analysis to calculate thresholds. In parallel, the same approach can be used for aeroplane type and/or for an aeroplane. In one embodiment, a second classifications step uses all of the reference bases to improve detection precision. Analysis can optionally be clarified using contextual data on the flight (human validation of the model).

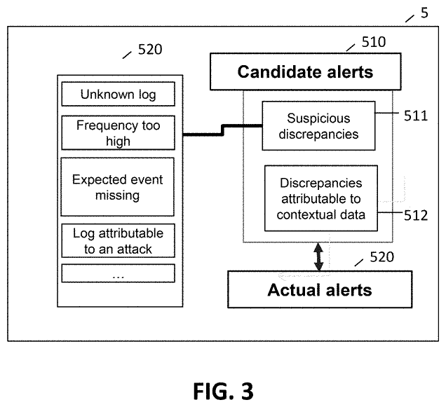

FIG. 3 shows an example embodiment of the step involving determining and/or issuing an alert (to the pilot and/or to another machine).

Anomalies 3 are identified by comparing the current data on an aircraft with one or more reference bases (maintained by learning).

On the basis of these anomalies 3, one or more attacks 4 can be identified (for example a type 1 attack is frequently associated with three type X, Y and Z anomalies, while a type 2 attack is marked by the presence of a type W anomaly.

Different technical modes enable a collection of anomalies to be transformed into a characterization of a cyberattack (for example: known patterns, graph analysis, heuristics, etc.).

Attacks can be characterized, notably in terms of impact on the availability of systems and/or the integrity of data in one or more aircraft.

FIG. 3 shows some details or examples relating to the management of anomalies, identifying attacks and decisions regarding alerts.

Anomalies 3 are identified by comparing the current data on an aircraft with one or more reference bases (maintained by learning).

Certain anomalies or discrepancies 511 can be deemed to be suspicious, while other discrepancies 512 can be linked to contextual data (in the context of the current flight). Suspicious discrepancies 511 can notably include one or more unknown logs, a record present at a frequency exceeding a predefined frequency threshold, an expected record that is absent from the data flow 250, a record typically associated with a listed attack (signature), etc. (not exhaustive).

The analyses performed on the anomalies or discrepancies 511 and 512 make it possible to decide which of the candidate alerts 510 are deemed to be real attacks, justifying one or more actual alerts 520.

The alerts can be sent to the person (for example the pilot, flight crew, airline company, ATC, etc.) and/or to the machine (for example the SOC, avionics system, etc.).

In one embodiment, the method also includes a step that involves displaying an alert or producing an alert in response to identification of a cyberattack.

In one embodiment, the content of an alert is associated with one or more notifications: (a) unreferenced application notifications, (b) notifications whose occurrence frequency exceeds the reference occurrence frequency according to a predefined threshold, (c) notifications that can be associated with a security event relating to specific hardware according to the supplier of said hardware, and/or (d) notifications in the reference whose presence has not been detected.

A system including means for implementing one or more steps of the method according to the invention is described.

In one embodiment, the system includes a plurality of processors arranged using a centralized or decentralized or distributed or dynamic architecture.

The ‘intelligence’ (logical data processing entity, including hardware submodules for performing the different logical steps of the method) can be distributed in different ways. In a centralized embodiment, the processes are (all) performed in a standalone ground system, or can be built into an SOC security centre. Different compromises between centralization (a single centre), decentralization (several centres) and distribution (no centre) are possible. Centralized processing advantageously enables data to be consolidated and information to be cross-referenced, which would not otherwise be the case, for example by linking same using common denominators.

In terms of hardware, these different architectures can result in different implementations or variations. Some examples are described below (and can usually be combined).

In a distributed embodiment, one of the aircraft in the fleet carries the reference database and also the processing logic on board. This aircraft implements two-way communication with the other aeroplanes in the aeroplane fleet. In a fully distributed embodiment, all of the aircraft share one copy of the data and have the logic implemented (systematically updated on the ground before each aeroplane flies), with ground equipment taking charge of updates during flights (for example by satellite).

In a decentralized embodiment (‘archipelago’), several major hubs/nodes/aeroplanes communicate with other equipment allocated thereto.

In a dynamic embodiment, the ‘distribution’ of the data and/or the ‘intelligence’ evolve dynamically over time (for example: at a given instant, the ground has data and processing capacity, then this set is allocated to an aeroplane A, which subsequently shares its own capacity with several aeroplanes B and C, etc.).

The compromise made may be a function of connectivity, attacks perpetrated, robustness levels or desired redundancy, etc.

The present invention may be implemented using hardware and/or software elements. The present invention may be made available as a computer program product on a computer readable support. The support may be electronic, magnetic, optical or electromagnetic.

1. A method for managing the security of an aircraft, including the following steps:
actively collecting and/or passively receiving records associated with the aircraft,
identifying one or more security anomalies as a function of one or more processes applied to said records.

2. The method according to claim 1, also including a step wherein one or more cyberattacks are identified as a function of one or more security anomalies.

3. The method according to claim 1, also including a step wherein one or more alerts are issued.

4. The method according to claim 1, wherein the processing step includes one or more of the following steps:
constitute and maintain reference data,
compare each record collected with said reference data.

5. The method according to claim 4, wherein the reference data includes descriptions or metadata or tags or labels associated with flight records to enable non-ambiguous imputation of a security anomaly to an on-board device.

6. The method according to claim 5, wherein said non-ambiguous imputation is effected during a predefined operating phase or a predefined flight phase.

7. The method according to claim 4, wherein one or more reference data are modified by machine learning.

8. The method according to claim 4, wherein the reference data include data associated with one or more information points including the registration of an aircraft, an aircraft type, a flight number, the identification of a flight, a time date expressed as year, month, day, hour, minute or second, a time interval, a flight time, an aeronautical service, a flight segment, an IATA code of the departure and/or arrival airport and/or the presence of at least one specific hardware device on board.

9. The method according to claim 1, wherein a process is carried out on a record to compare said flight record with the reference data.

10. The method according to claim 9, wherein the comparison step is triggered on demand from the ground and/or as a function of a flight context.

11. The method according to claim 1, wherein a process involves carrying out a comparative statistical analysis of the data collected with the reference data.

12. The method according to claim 11, wherein said comparative statistical analysis is carried out for a given aircraft.

13. The method according to claim 11, wherein said comparative statistical analysis is carried out for several aircraft.

14. The method according to claim 1, wherein one or more of the records collected and/or received are associated with one or more aircraft.

15. The method according to claim 1, also including a step in which feedback regarding any one of the steps in the preceding claims is received.

16. A computer program product, said computer program including code instructions enabling the steps of the method according to claim 1 to be carried out when said program is run on a computer.

17. A system for managing the security of an aircraft, wherein the system comprises one or more processors configured to actively collect and/or passively receive records associated with the aircraft, identifying one or more security anomalies as a function of one or more processes applied to said records.

18. The system according to claim 17, wherein the plurality of processors is arranged using a centralized or decentralized or distributed architecture.
